(19) United States
(12) Patent Application Publication
(10) Pub. No.: US 2025/0312749 A1
(43) Pub. Date: Oct. 9, 2025

(54) POLYAMIDINE-CONTAINING MEMBRANES FOR CO2 SEPARATIONS FROM GASEOUS STREAMS

(71) Applicant: Ohio State Innovation Foundation, Columbus, OH (US)

(72) Inventors: Yang HAN, Columbus, OH (US); W.S. Winston HO, Columbus, OH (US); Jingying HU, Columbus, OH (US)

(21) Appl. No.: 18/860,511

(22) PCT Filed: Feb. 27, 2023
(86) PCT No.: PCT/US2023/063348

§ 371 Date: Oct. 25, 2024

Related U.S. Application Data
(60) Provisional application No. 63/335,496, filed on Apr. 27, 2022.

(51) Int. Cl. B01D 71/56; B01D 53/22; B01D 69/02; B01D 69/10; B01D 69/14; B01D 71/02; B01D 71/60

(52) U.S. Cl. CPC B01D 71/56; B01D 53/228; B01D 69/02; B01D 69/107; B01D 69/14111; B01D 71/0211; B01D 71/60; B01D 2257/504; B01D 2325/34; B01D 2325/36

(57) ABSTRACT

Membranes, methods of making the membranes, and methods of using the membranes are described herein. The membrane can include a support layer, and a selective polymer layer disposed on the support layer. The selective polymer layer can include a selective polymer matrix that comprises a mobile carrier comprising a sterically hindered amine or a salt thereof. The selective polymer matrix can further comprise, for example, a hydrophilic polymer, a cross-linking agent, an amine-containing polymer, or a combination thereof. The membranes can be used to separate hydrogen sulfide from carbon dioxide. Also provided are methods of purifying syngas using the membranes described herein.

### CROSS-REFERENCE TO RELATED APPLICATIONS

This application claims benefit of U.S. Provisional Application No. 63/335,496, filed Apr. 27, 2022, which is hereby incorporated herein by reference in its entirety.

### STATEMENT REGARDING FEDERALLY SPONSORED RESEARCH OR DEVELOPMENT

This disclosure was made with Government Support under Grant No. DE-FE0031731 awarded by U.S. Department of Energy. The Government has certain rights to this disclosure.

### BACKGROUND

CO₂ emissions in the world declined by 5.8% in 2020, or almost 2 giga tonne (Gt) carbon dioxide, which was the largest ever decline due to the COVID-19 pandemic [1]. Despite this decline, energy-related CO₂ emissions remained high at 31.5 Gt, and this contributed to CO₂ reaching its highest ever average annual concentration in the atmosphere of 412.5 ppm in 2020 [1]. In 2016, the combustion of coal still accounts for 50% electricity supply and about a third of CO₂ emissions in the U.S. [2]. Carbon capture and storage could play an important role in cutting the carbon footprint in the energy sector.

Retrofitting a current coal-fired power plant by an amine solution-based capture system would increase the cost of electricity by 70-80% and incur a 25-40% energy penalty [3]. However, membranes, as one of the promising next-generation technologies, have been implemented in many industrial applications such as hydrogen recovery, air separation, and natural gas sweetening [4].

While some membrane technologies have been explored, there remains a need for improved membranes for CO₂ separations from gaseous streams.

### SUMMARY

Disclosed herein are selective membranes that can exhibit high CO₂ selectivity, high CO₂ permeability, or a combination thereof. The membranes can be used to separate carbon dioxide from gas streams.

For example, provided herein are membranes that comprise a support layer, and a selective polymer layer disposed on the support layer. The selective polymer layer can comprise a selective polymer matrix.

The support layer can be a gas permeable layer comprising a gas permeable polymer. The gas permeable polymer can comprise a polyamide, a polyimide, a polypyrrolone, a polyester, a sulfone-based polymer, a polymeric organosilicone, a fluorinated polymer, a polyolefin, a copolymer thereof, or a blend thereof. In some embodiments, the gas permeable polymer can comprise a polyethersulfone. In certain cases, the support layer can comprise a gas permeable polymer disposed on a base (e.g., a nonwoven fabric such as a polyester nonwoven).

The selective polymer matrix can comprise a fixed carrier comprising a polyamidine. In some embodiments, the selective polymer layer can further comprise a hydrophilic polymer, a cross-linking agent, amine-containing polymer, a mobile carrier, or a combination thereof.

The polyamidine has a weight average molecular weight of at least 2,500 Da, such as at least 5,000 Da, or at least 10,000 Da. In some examples, the polyamidine can be chosen from polyethylene formamidine, polytrimethylene formamidine, polytetramethylene formamidine, polypentamethylene formamidine, polyhexamethylene formamidine, polyheptamethylene formamidine, polyoctamethylene formamidine, polyethylene acetamidine, polytrimethylene acetamidine, polytetramethylene acetamidine, polypentamethylene acetamidine, polyhexamethylene acetamidine, polyheptamethylene acetamidine, polyoctamethylene acetamidine, poly(N-vinylamidine), poly(N-allylamidine), poly(N-butylamidine), poly(N-pentylamidine), poly(N-hexylamidine), poly(N-heptylamidine), poly(N-octylamidine), poly(5-member ring amidine) derived from N-vinylamine-co-acrylonitrile, copolymers thereof, and blends thereof. In certain embodiments, the polyamidine comprises polytetramethylene formamidine (PTF), polyethylene formamidine (PEF), or a blend thereof.

In some embodiments, the selective polymer layer can further comprise a hydrophilic polymer, a cross-linking agent, amine-containing polymer, a mobile carrier, or a combination thereof.

In certain embodiments, the selective polymer layer further comprises a mobile carrier. The mobile carrier can have a molecular weight of less than 1,000 Da. In some embodiments, the mobile carrier can comprise a low molecular weight amino compound. For example, the mobile carrier can comprise 1,1,3,3-tetramethylguanidine, piperazine-1-carboximidamide, N-methylpiperazine-1-carboximidamide, N-ethylpiperazine-1-carboximidamide, N-propylpiperazine-1-carboximidamide, N-butylpiperazine-1-carboximidamide, N-pentylpiperazine-1-carboximidamide, N-hexylpiperazine-1-carboximidamide, N-heptylpiperazine-1-carboximidamide, N-octylpiperazine-1-carboximidamide, 2-(1-piperazinyl)ethylamine sarcosinate, 2-(1-piperazinyl)ethylamine glycinate, 2-(1-piperazinyl)ethylamine aminoisobutyrate, piperazine sarcosinate, piperazine glycinate, piperazine aminoisobutyrate, lithium sarcosinate, lithium glycinate, lithium aminoisobutyrate, potassium sarcosinate, potassium glycinate, potassium aminoisobutyrate, an amidine with the structure R₁—(C═NH)—NR₂R₃ where each of R₁, R₂, and R₃ groups being H or R═CₙH₂ₙ₊₁ with n ranging from 1 to 10, guanidine with the structure R₁—N(R₂)—(C═NH)'NR₂R₄ where each of R₁, R₂, R₃, and R₄ groups being H or R═CₙH₂ₙ₊₁ with n ranging from 1 to 10, or a combination thereof.

In some embodiments, the selective polymer matrix can further comprise a hydrophilic polymer and a cross-linking agent. The cross-linking agent can be selected from the group consisting of formaldehyde, glutaraldehyde, maleic anhydride, glyoxal, divinylsulfone, toluenediisocyanate, trimethylol melamine, terephthalatealdehyde, epichlorohydrin, vinyl acrylate, an aminosilane cross-linking agent, and combinations thereof. The hydrophilic polymer can comprise a polymer selected from the group consisting of polyvinylalcohol, polyvinylacetate, polyethylene oxide, polyvinylpyrrolidone, polyarylamine, and copolymers thereof, or blends thereof.

In some embodiments, the selective polymer matrix can further comprise an amine-containing polymer. The amine-containing polymer can be selected from the group consisting of polyvinylamine, polyallylamine, polyethyleneimine, poly-N-isopropylallylamine, poly-N-tert-butylallylamine, poly-N-1,2-dimethylpropylallylamine, poly-N-methylallylamine, poly-N,N-dimethylallylamine, poly-2-vinylpiperidine, poly-4-vinylpiperidine, polyaminostyrene, chitosan, copolymers, and blends thereof.

In some embodiments, the selective polymer layer can further comprise graphene oxide dispersed therein.

The membranes can be used to separate carbon dioxide from gas streams. The membranes can exhibit selective permeability towards gases, such as carbon dioxide. In certain embodiments, the membranes can exhibit a CO₂:N₂ selectivity of at least 50 (e.g., from 50 to 300) at 77° C. and 4 atm feed pressure. In certain embodiments, the membranes can exhibit an CO₂ permeance of at least 750 GPU (e.g., from 750 GPU to 6000 GPU) at 77° C. and 4 atm feed pressure.

Also provided are methods for separating CO₂ gas from a gas stream comprising CO₂ and a second gas. These methods can comprise contacting a membrane described herein with the feed gas stream comprising the CO₂ under conditions effective to afford transmembrane permeation of the CO₂.

The details of one or more embodiments of the disclosure are set forth in the accompanying drawings and the description below. Other features, objects, and advantages of the disclosure will be apparent from the description and drawings, and from the claims.

### DESCRIPTION OF DRAWINGS

FIG. 1 shows the structure of

FIG. 2 shows a 400 MHz ¹H NMR spectrum of PEF using D₂O as the solvent.

FIG. 3 shows the IR spectrum of PEF.

FIG. 4 shows a 400 MHz ¹H NMR spectrum of PTF using D₂O as the solvent.

FIG. 5 is a plot showing the IR spectrum of PTF.

FIG. 6 is a plot showing the CO₂ and N₂ permeance of membranes including differing weight percentages of PEF and PVA.

FIG. 7 is a plot showing the CO₂ permeances and CO₂/N₂ selectivities of membranes including different amounts of PEF. All membranes included 5 wt. % PVAm, 20 wt. % PZEA-Sar, 20 wt. % PZC, PEF (in varying quantities), with the balance being PTF.

FIG. 8 is a plot showing the CO₂ permeances and CO₂/N₂ selectivities of membranes including PVA, PZEA-Sar, and different amounts of PEF.

### DETAILED DESCRIPTION

### Definitions

To facilitate understanding of the disclosure set forth herein, a number of terms are defined below. Unless defined otherwise, all technical and scientific terms used herein generally have the same meaning as commonly understood by one of ordinary skill in the art to which this disclosure belongs. Publications cited herein and the materials for which they are cited are specifically incorporated by reference.

### General Definitions

As used in this specification and the following claims, the terms “comprise” (as well as forms, derivatives, or variations thereof, such as “comprising” and “comprises”) and “include” (as well as forms, derivatives, or variations thereof, such as “including” and “includes”) are inclusive (i.e., open-ended) and do not exclude additional elements or steps. For example, the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof. Other than where noted, all numbers expressing quantities of ingredients, reaction conditions, geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Accordingly, these terms are intended to not only cover the recited element(s) or step(s), but may also include other elements or steps not expressly recited. Furthermore, as used herein, the use of the terms “a”, “an”, and “the” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. A range may be construed to include the start and the end of the range. For example, a range of 10% to 20% (i.e., range of 10/6-20%) can includes 10% and also includes 20%, and includes percentages in between 10% and 20%, unless explicitly stated otherwise herein.

As used herein, the terms “may,” “optionally,” and “may optionally” are used interchangeably and are meant to include cases in which the condition occurs as well as cases in which the condition does not occur. Thus, for example, the statement that a formulation “may include an excipient” is meant to include cases in which the formulation includes an excipient as well as cases in which the formulation does not include an excipient.

A “control” is an alternative subject or sample used in an experiment for comparison purposes. A control can be “positive” or “negative.”

### Chemical Definitions

Terms used herein will have their customary meaning in the art unless specified otherwise. The organic moieties mentioned when defining variable positions within the general formulae described herein (e.g., the term “halogen”) are collective terms for the individual substituents encompassed by the organic moiety. Ph in Formula I refers to a phenyl group.

As used herein, “alkyl” means a straight or branched chain saturated hydrocarbon moieties such as those containing from 1 to 10 carbon atoms. A “higher alkyl” refers to saturated hydrocarbon having 11 or more carbon atoms. A “C₆-C₁₆” refers to an alkyl containing 6 to 16 carbon atoms. Likewise, a “C₆-C₂₂” refers to an alkyl containing 6 to 22 carbon atoms. Representative saturated straight chain alkyls include methyl, ethyl, n-propyl, n-butyl, n-pentyl, n-hexyl, n-septyl, n-octyl, n-nonyl, and the like; while saturated branched alkyls include isopropyl, sec-butyl, isobutyl, tert-butyl, isopentyl, and the like.

As used herein, the term “alkenyl” refers to unsaturated, straight or branched hydrocarbon moieties containing a double bond. Unless otherwise specified, C₂-C₂₄ (e.g., C₂-C₂₂, C₂-C₂₀, C₂-C₁₈, C₂-C₁₆, C₂-C₁₄, C₂-C₁₂, C₂-C₁₀, C₂-C₈, C₂-C₆, or C₂-C₄) alkenyl groups are intended. Alkenyl groups may contain more than one unsaturated bond. Examples include ethenyl, 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl, 2-methyl-2-propenyl, 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl, and 1-ethyl-2-methyl-2-propenyl. The term “vinyl” refers to a group having the structure —CH═CH₂; 1-propenyl refers to a group with the structure-CH═CH—CH₃, and 2-propenyl refers to a group with the structure —CH₂—CH═CH₂. Asymmetric structures such as (Z¹Z²)C═C(Z³Z⁴) are intended to include both the E and Z isomers. This can be presumed in structural formulae herein wherein an asymmetric alkene is present, or it can be explicitly indicated by the bond symbol C═C.

As used herein, the term “alkynyl” represents straight or branched hydrocarbon moieties containing a triple bond. Unless otherwise specified, C₂-C₂₄ (e.g., C₂-C₂₄, C₂-C₂₀, C₂-C₁₈, C₂-C₁₆, C₂-C₁₄, C₂-C₁₂, C₂-C₁₀, C₂-C₈, C₂-C₆, or C₂-C₄) alkynyl groups are intended. Alkynyl groups may contain more than one unsaturated bond. Examples include C₂-C₆-alkynyl, such as ethynyl, 1-propynyl, 2-propynyl (or propargyl), 1-butynyl, 2-butynyl, 3-butynyl, 1-methyl-2-propynyl, 1-pentynyl, 2-pentynyl, 3-pentynyl, 4-pentynyl, 3-methyl-1-butynyl, 1-methyl-2-butynyl, 1-methyl-3-butynyl, 2-methyl-3-butynyl, 1,1-dimethyl-2-propynyl, 1-ethyl-2-propynyl, i-hexynyl, 2-hexynyl, 3-hexynyl, 4-hexynyl, 5-hexynyl, 3-methyl-1-pentynyl, 4-methyl-1-pentynyl, 1-methyl-2-pentynyl, 4-methyl-2-pentynyl, 1-methyl-3-pentynyl, 2-methyl-3-pentynyl, 1-methyl-4-pentynyl, 2-methyl-4-pentynyl, 3-methyl-4-pentynyl, 1,1-dimethyl-2-butynyl, 1,1-dimethyl-3-butynyl, 1,2-dimethyl-3-butynyl, 2,2-dimethyl-3-butynyl, 3,3-dimethyl-1-butynyl, 1-ethyl-2-butynyl, 1-ethyl-3-butynyl, 2-ethyl-3-butynyl, and 1-ethyl-1-methyl-2-propynyl.

Non-aromatic mono or polycyclic alkyls are referred to herein as “carbocycles” or “carbocyclyl” groups. Representative saturated carbocycles include cyclopropyl, cyclobutyl, cyclopentyl, cyclohexyl, and the like; while unsaturated carbocycles include cyclopentenyl and cyclohexenyl, and the like.

“Heterocarbocycles” or “heterocarbocyclyl” groups are carbocycles which contain from 1 to 4 heteroatoms independently selected from nitrogen, oxygen and sulfur which can be saturated or unsaturated (but not aromatic), monocyclic or polycyclic, and wherein the nitrogen and sulfur heteroatoms can be optionally oxidized, and the nitrogen heteroatom can be optionally quaternized. Heterocarbocycles include morpholinyl, pyrrolidinonyl, pyrrolidinyl, piperidinyl, hydantoinyl, valerolactamyl, oxiranyl, oxetanyl, tetrahydrofuranyl, tetrahydropyranyl, tetrahydropyridinyl, tetrahydroprimidinyl, tetrahydrothiophenyl, tetrahydrothiopyranyl, tetrahydropyrimidinyl, tetrahydrothiophenyl, tetrahydrothiopyranyl, and the like.

The term “aryl” refers to aromatic homocyclic (i.e., hydrocarbon) mono-, bi- or tricyclic ring-containing groups preferably having 6 to 12 members such as phenyl, naphthyl and biphenyl. Phenyl is a preferred aryl group. The term “substituted aryl” refers to aryl groups substituted with one or more groups, preferably selected from alkyl, substituted alkyl, alkenyl (optionally substituted), aryl (optionally substituted), heterocyclo (optionally substituted), halo, hydroxy, alkoxy (optionally substituted), aryloxy (optionally substituted), alkanoyl (optionally substituted), aroyl, (optionally substituted), alkylester (optionally substituted), arylester (optionally substituted), cyano, nitro, amino, substituted amino, amido, lactam, urea, urethane, sulfonyl, and, the like, where optionally one or more pair of substituents together with the atoms to which they are bonded form a 3 to 7 member ring.

As used herein, “heteroaryl” or “heteroaromatic” refers an aromatic heterocarbocycle having 1 to 4 heteroatoms selected from nitrogen, oxygen and sulfur, and containing at least 1 carbon atom, including both mono- and polycyclic ring systems. Polycyclic ring systems can, but are not required to, contain one or more non-aromatic rings, as long as one of the rings is aromatic. Representative heteroaryls are furyl, benzofuranyl, thiophenyl, benzothiophenyl, pyrrolyl, indolyl, isoindolyl, azaindolyl, pyridyl, quinolinyl, isoquinolinyl, oxazolyl, isooxazolyl, benzoxazolyl, pyrazolyl, imidazolyl, benzimidazolyl, thiazolyl, benzothiazolyl, isothiazolyl, pyridazinyl, pyrimidinyl, pyrazinyl, triazinyl, cinnolinyl, phthalazinyl, and quinazolinyl. It is contemplated that the use of the term “heteroaryl” includes N-alkylated derivatives such as a 1-methylimidazol-5-yl substituent.

As used herein, “heterocycle” or “heterocyclyl” refers to mono- and polycyclic ring systems having 1 to 4 heteroatoms selected from nitrogen, oxygen and sulfur, and containing at least 1 carbon atom. The mono- and polycyclic ring systems can be aromatic, non-aromatic or mixtures of aromatic and non-aromatic rings. Heterocycle includes heterocarbocycles, heteroaryls, and the like.

“Alkylthio” refers to an alkyl group as defined above with the indicated number of carbon atoms attached through a sulfur bridge. An example of an alkylthio is methylthio, (i.e., —S—CH₃).

“Alkoxy” refers to an alkyl group as defined above with the indicated number of carbon atoms attached through an oxygen bridge. Examples of alkoxy include, but are not limited to, methoxy, ethoxy, n-propoxy, i-propoxy, n-butoxy, s-butoxy, t-butoxy, n-pentoxy, and s-pentoxy. Preferred alkoxy groups are methoxy, ethoxy, n-propoxy, i-propoxy, n-butoxy, s-butoxy, t-butoxy.

“Alkylamino” refers an alkyl group as defined above with the indicated number of carbon atoms attached through an amino bridge. An example of an alkylamino is methylamino, (i.e., —NH—CH₃).

“Alkanoyl” refers to an alkyl as defined above with the indicated number of carbon atoms attached through a carbonyl bride (i.e., —(C═O)alkyl).

“Alkylsulfonyl” refers to an alkyl as defined above with the indicated number of carbon atoms attached through a sulfonyl bridge (i.e., —S(═O)₂alkyl) such as mesyl and the like, and “Arylsulfonyl” refers to an aryl attached through a sulfonyl bridge (i.e., —S(═O)₂aryl).

“Alkylsulfamoyl” refers to an alkyl as defined above with the indicated number of carbon atoms attached through a sulfamoyl bridge (i.e., —NHS(═O)₂alkyl), and an “Arylsulfamoyl” refers to an alkyl attached through a sulfamoyl bridge (i.e., —NHS(═O)₂aryl).

“Alkylsulfinyl” refers to an alkyl as defined above with the indicated number of carbon atoms attached through a sulfinyl bridge (i.e. —S(═O)alkyl).

The terms “cycloalkyl” and “cycloalkenyl” refer to mono-, bi-, or tri homocyclic ring groups of 3 to 15 carbon atoms which are, respectively, fully saturated and partially unsaturated. The term “cycloalkenyl” includes bi- and tricyclic ring systems that are not aromatic as a whole, but contain aromatic portions (e.g., fluorene, tetrahydronapthalene, dihydroindene, and the like). The rings of multi-ring cycloalkyl groups can be either fused, bridged and/or joined through one or more spiro unions. The terms “substituted cycloalkyl” and “substituted cycloalkenyl” refer, respectively, to cycloalkyl and cycloalkenyl groups substituted with one or more groups, preferably selected from aryl, substituted aryl, heterocyclo, substituted heterocyclo, carbocyclo, substituted carbocyclo, halo, hydroxy, alkoxy (optionally substituted), aryloxy (optionally substituted), alkylester (optionally substituted), arylester (optionally substituted), alkanoyl (optionally substituted), aryol (optionally substituted), cyano, nitro, amino, substituted amino, amido, lactam, urea, urethane, sulfonyl, and the like.

The terms “halogen” and “halo” refer to fluorine, chlorine, bromine, and iodine.

The term “substituted” refers to a molecule wherein at least one hydrogen atom is replaced with a substituent. When substituted, one or more of the groups are “substituents.” The molecule can be multiply substituted. In the case of an oxo substituent (“═O”), two hydrogen atoms are replaced. Example substituents within this context can include halogen, hydroxy, alkyl, alkoxy, nitro, cyano, oxo, carbocyclyl, carbocycloalkyl, heterocarbocyclyl, heterocarbocycloalkyl, aryl, arylalkyl, heteroaryl, heteroarylalkyl, —NRaRb, —NRaC(═O)Rb, —NRaC(═O)NRaNRb, —NRaC(═O)ORb, —NRaSO₂Rb, —C(═O)Ra, —C(═O)ORa, —C(═O)NRaRb, —OC(═O)NRaRb, —ORa, —SRa, —SORa, —S(═O)₂Ra, —OS(═O)₂Ra and —S(═O)₂ORa. Ra and Rb in this context can be the same or different and independently hydrogen, halogen hydroxyl, alkyl, alkoxy, alkyl, amino, alkylamino, dialkylamino, carbocyclyl, carbocycloalkyl, heterocarbocyclyl, heterocarbocycloalkyl, aryl, arylalkyl, heteroaryl, heteroarylalkyl.

The term “optionally substituted,” as used herein, means that substitution with an additional group is optional and therefore it is possible for the designated atom to be unsubstituted. Thus, by use of the term “optionally substituted” the disclosure includes examples where the group is substituted and examples where it is not.

Reference will now be made in detail to specific aspects of the disclosed materials, compounds, compositions, articles, and methods, examples of which are illustrated in the accompanying Examples and Figures.

### Membranes

Membranes, methods of making the membranes, and methods of using the membranes are described herein. The membranes can comprise a gas permeable support layer, and a selective polymer layer disposed on the gas permeable support layer. The gas permeable support layer and the selective polymer layer can optionally comprise one or more sub-layers.

In some embodiments, the membrane can have an CO₂:N₂ selectivity of at least 50 at 77° C. and 4 atm feed pressure. For example, the membrane can have a CO₂:N₂ selectivity of at least 50 (e.g., at least 100, at least 150, at least 200, or at least 250) at 77° C. and 4 atm feed pressure. In some embodiments, the membrane can have a CO₂:N₂ selectivity of 300 or less (e.g., 250 or less, 200 or less, 150 or less, or 100 or less) at 77° C. and 4 atm feed pressure.

In certain embodiments, the membrane can have a CO₂:N₂ selectivity ranging from any of the minimum values described above to any of the maximum values described above. For example, in certain embodiments, the membrane can have a CO₂:N₂ selectivity of from 50 to 300 at 77° C. and 4 atm feed pressure (e.g., from 50 to 250 at 77° C. and 4 atm feed pressure). The CO₂:N₂ selectivity of the membrane can be measured using standard methods for measuring gas permeance known in the art, such as those described in the examples below.

In some embodiments, the membrane can have a CO₂ permeance of at least 750 GPU (e.g., 1000 GPU or greater, 1500 GPU or greater, 2000 GPU or greater, 2500 GPU or greater, 3000 GPU or greater, 3500 GPU or greater, 4000 GPU or greater, 4500 GPU or greater, 5000 GPU or greater, or 5500 GPU or greater) at 77° C. and 4 atm feed pressure.

In some embodiments, the membrane can have a CO₂ permeance of 6000 GPU or less at 77° C. and 4 atm feed pressure (e.g., 5500 GPU or less, 5000 GPU or less, 4500 GPU or less, 4000 GPU or less, 3500 GPU or less, 3000 GPU or less, 2500 GPU or less, 2000 GPU or less, 1500 GPU or less, or 1000 GPU or less).

The CO₂ permeance through the membrane can vary from any of the minimum values described above to any of the maximum values described above. For example, in some embodiments, the membrane can have a CO₂ permeance of from 750 GPU to 6000 GPU at 77° C. and 4 atm feed pressure (e.g., from 1000 GPU to 4500 GPU).

### Gas Permeable Support Layer

The support layer can be formed from any suitable material. The material used to form the support layer can be chosen based on the end use application of the membrane. In some embodiments, the support layer can comprise a gas permeable polymer. The gas permeable polymer can be a cross-linked polymer, a phase separated polymer, a porous condensed polymer, or a blend thereof. Examples of suitable gas permeable polymers include polyamides, polyimides, polypyrrolones, polyesters, sulfone-based polymers, nitrile-based polymers, polymeric organosilicones, fluorinated polymers, polyolefins, copolymers thereof, or blends thereof. Specific examples of polymers that can be present in the support layer include polydimethylsiloxane, polydiethylsiloxane, polydi-isopropylsiloxane, polydiphenylsiloxane, polyethersulfone, polyphenylsulfone, polysulfone, polyacrylonitrile, polyvinylidene fluoride, polyamide, polyimide, polyetherimide, polyetheretherketone, polyphenylene oxide, polybenzimidazole, polypropylene, polyethylene, partially fluorinated, perfluorinated or sulfonated derivatives thereof, copolymers thereof, or blends thereof. In some embodiments, the gas permeable polymer can be polysulfone or polyethersulfone. If desired, the support layer can include inorganic particles to increase the mechanical strength without altering the permeability of the support layer.

In certain embodiments, the support layer can comprise a gas permeable polymer disposed on a base. The base can be in any configuration configured to facilitate formation of a membrane suitable for use in a particular application. For example, the base can be a flat disk, a tube, a spiral wound, or a hollow fiber base. The base can be formed from any suitable material. In some embodiments, the layer can include a fibrous material. The fibrous material in the base can be a mesh (e.g., a metal or polymer mesh), a woven or non-woven fabric, a glass, fiberglass, a resin, a screen (e.g., a metal or polymer screen). In certain embodiments, the base can include a non-woven fabric (e.g., a non-woven fabric comprising fibers formed from a polyester).

### Selective Polymer Layer

The selective polymer layer can include a selective polymer matrix. The selective polymer matrix can comprise a polyamidine (a fixed carrier). The selective polymer matrix can include a hydrophilic polymer, an amine-containing polymer (a fixed carrier), a mobile carrier (e.g., a low molecular weight amine or a salt thereof), a cross-linking agent, or a combination thereof.

In some embodiments, the selective polymer layer can be a selective polymer matrix through which CO₂ permeates via diffusion or facilitated diffusion.

### Polyamidines

The selective polymer matrix can comprise a fixed carrier comprising a polyamidine.

Any suitable polyamidine can be used. For example, the polyamidine can be polyethylene formamidine, polytrimethylene formamidine, polytetramethylene formamidine, polypentamethylene formamidine, polyhexamethylene formamidine, polyheptamethylene formamidine, polyoctamethylene formamidine, polyethylene acetamidine, polytrimethylene acetamidine, polytetramethylene acetamidine, polypentamethylene acetamidine, polyhexamethylene acetamidine, polyheptamethylene acetamidine, polyoctamethylene acetamidine, poly(N-vinylamidine), poly(N-allylamidine), poly(N-butylamidine), poly(N-pentylamidine), poly(N-hexylamidine), poly(N-heptylamidine), poly(N-octylamidine), poly(5-member ring amidine) derived from N-vinylamine-co-acrylonitrile, a copolymer thereof, or a blend thereof. In some embodiments, the polyamidine can comprise polytetramethylene formamidine (PTF), polyethylene formamidine (PEF), or a blend thereof.

In some embodiments, the polyamidine can have any suitable molecular weight. For example, the polyamidine polymer can have a weight average molecular weight of at least 2,500 Da, such as at least 5,000 Da, or at least 10,000 Da. In some embodiments, the polyamidine can have a weight average molecular weight of from 2,500 Da to 2,000,000 Da (e.g., from 2,500 Da to 200,000 Da).

The selective polymer layer can include any suitable amount of the polyamidine polymer. For example, in some cases, the selective polymer layer can include from 10% to 90% by weight (e.g., from 10% to 50% by weight, or from 10% to 30% by weight) polyamidine, based on the total weight of the components used to form the selective polymer layer.

### Cross-Linking Agents

The selective polymer matrix can include a cross-linking agent. Cross-linking agents suitable for use in the selective polymer matrix can include, but are not limited to, aminosilane, formaldehyde, glutaraldehyde, maleic anhydride, glyoxal, divinylsulfone, toluenediisocyanate, trimethylol melamine, terephthalatealdehyde, epichlorohydrin, or vinyl acrylate, and combinations thereof.

In some embodiments, the cross-linking agent can include aminosilane. In some embodiments, the cross-linking agent can include aminosilane and glyoxal. The selective polymer matrix can include any suitable amount of the cross-linking agent. For example, the selective polymer matrix can comprise 1 to 70 percent cross-linking agents by weight of the selective polymer matrix. In some embodiments, die cross-linking agent can be at least 30%, at least 35%, at least 40% or at least 50%. In some embodiments, the cross-linking agent can be 40% aminosilane and 20% glyoxal by weight of the selective polymer matrix. In some embodiments, the cross-linking agent can be 35% aminosilane and 25% glyoxal by weight of the selective polymer matrix.

In some cases, the cross-linking agent can be an aminosilane tetravalent single bonded Si with at least one substituent containing an amino group(s) defined by formula I below

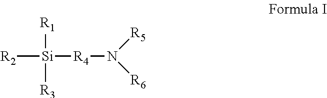

wherein R₁-R₃ are each independently selected from hydrogen, substituted or unsubstituted alkyl, alkenyl, alkynyl, alkoxy, aryl, heteroaryl, cycloalkyl, or heterocyclyl; R₄ is selected from substituted or unsubstituted alkyl, alkenyl, alkynyl, or alkoxy; and R₅ and R₆ are each independently selected from hydrogen, substituted or unsubstituted alkyl, alkenyl, alkynyl, alkoxy, aryl, heteroaryl, cycloalkyl, or heterocyclyl; or R₅ and R₆, together with the atoms to which they are attached, form a five- or a six-membered heterocycle;
wherein at least one R₁, R₂ or R₃ is a substituted or unsubstituted alkoxy.

In some cases, the cross-linking agent can be an aminosilane of Formula I, wherein R₁-R₃ are each independently selected from hydrogen, substituted or unsubstituted alkyl, alkenyl, alkynyl, alkoxy, aryl, heteroaryl, cycloalkyl, or heterocyclyl; R₄ is selected from substituted or unsubstituted alkyl; and R₅ and R₆ are each independently selected from hydrogen, substituted or unsubstituted alkyl, alkenyl, alkynyl, alkoxy, aryl, heteroaryl, cycloalkyl, or heterocyclyl; or R₅ and R₆, together with the atoms to which they are attached, form a five- or a six-membered heterocycle;
wherein at least one R₁, R₂ or R₃ is a substituted or unsubstituted alkoxy.

In some cases, the cross-linking agent can be an aminosilane of Formula I, wherein R₁-R₃ are each independently selected from hydrogen, substituted or unsubstituted alkyl, alkenyl, alkynyl, alkoxy, aryl, heteroaryl, cycloalkyl, or heterocyclyl; R₄ is selected from substituted or unsubstituted alkyl; and R₅ and R₆ are each independently selected from hydrogen, or substituted or unsubstituted alkyl;
wherein at least one R₁, R₂ or R₃ is a substituted or unsubstituted alkoxy.

### Hydrophilic Polymers

The selective polymer matrix can include any suitable hydrophilic polymer. In some embodiments, the hydrophilic polymer is crosslinked with an aminosilane defined by Formula I. Examples of hydrophilic polymers suitable for use in the selective polymer layer can include polyvinylalcohol, polyvinylacetate, polyethylene oxide, polyvinylpyrrolidone, polyacrylamine, a polyamine such as polyallylamine, polyvinyl amine, or polyethylenimine, copolymers thereof, and blends thereof. In some embodiments, the hydrophilic polymer includes polyvinylalcohol.

The selective polymer matrix can include any suitable crosslinked hydrophilic polymer (e.g., aminosilane crosslinked polyvinyl alcohol).

When present, the hydrophilic polymer can have any suitable molecular weight. For example, the hydrophilic polymer can have a weight average molecular weight of from 15,000 Da to 2,000,000 Da (e.g., from 50,000 Da to 200,000 Da). In some embodiments, the hydrophilic polymer can include polyvinyl alcohol having a weight average molecular weight of from 50,000 Da to 150,000 Da. In other embodiments, the hydrophilic polymer can be a high molecular weight hydrophilic polymer. For example, the hydrophilic polymer can have a weight average molecular weight of at least 500,000 Da (e.g., at least 700,000 Da, or at least 1,000,000 Da).

The selective polymer layer can include any suitable amount of the hydrophilic polymer. For example, in some cases, the selective polymer layer can include from 10% to 90% by weight (e.g., from 10% to 50% by weight, or from 10% to 30% by weight) hydrophilic polymer, based on the total weight of the components used to form the selective polymer layer.

When present, the crosslinked hydrophilic polymer can have any suitable molecular weight. For example, the crosslinked hydrophilic polymer can have a weight average molecular weight of from 15,000 Da to 2,000,000 Da (e.g., from 50,000 Da to 200,000 Da). In some embodiments, the crosslinked hydrophilic polymer can include aminosilane crosslinked polyvinyl alcohol having a weight average molecular weight of from 50,000 Da to 150,000 Da. In other embodiments, the crosslinked hydrophilic polymer can be a high molecular weight crosslinked hydrophilic polymer. For example, the crosslinked hydrophilic polymer can have a weight average molecular weight of at least 500,000 Da (e.g., at least 700,000 Da, or at least 1,000,000 Da).

The selective polymer layer can include any suitable amount of the crosslinked hydrophilic polymer. For example, in some cases, the selective polymer layer can include from 10% to 90% by weight (e.g., from 10% to 50% by weight, or from 10% to 30% by weight) crosslinked hydrophilic polymer, based on the total weight of the components used to form the selective polymer layer.

### Mobile Carriers

The selective polymer matrix can comprise a mobile carrier, such as a low molecular weight amino compound. For example, the mobile carrier can comprise a salt of a primary amine or a salt of a secondary amine.

In some embodiments, the mobile carrier (i.e., the low molecular weight amino compound or a salt thereof) can have a molecular weight of less than 1,000 Da (e.g., 800 Da or less, 500 or less, 300 Da or less, or 250 Da or less). In some embodiments, the mobile carrier can be non-volatile at the temperatures at which the membrane will be stored or used.

In some cases, the mobile carrier can include an amino acid salt. The amino acid salt can be a salt of any suitable amino acid. The amino acid salt may be derived, for instance, from glycine, arginine, lysine, histidine, 6-aminohexanoic acid, proline, sarcosine, methionine, or taurine. In some cases, the amino acid salt can comprise a salt of a compound defined by the formula below

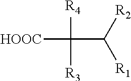

wherein, independently for each occurrence in the amino acid, each of R₁, R₂, R₃ and R₄ is selected from one of the following

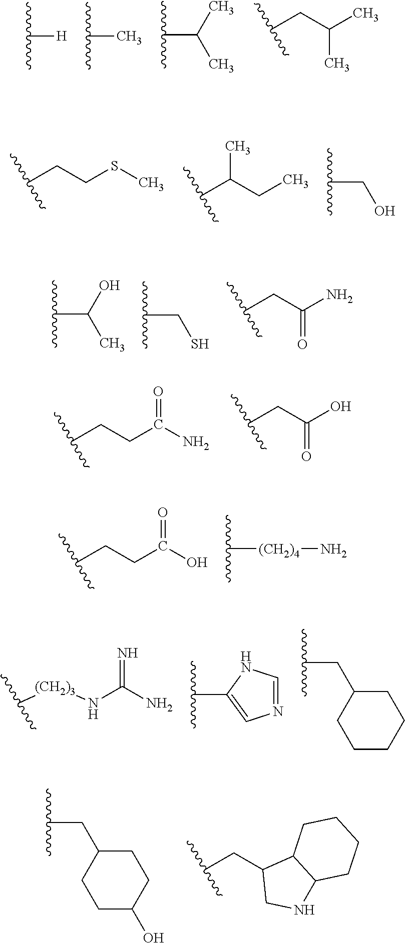

or R₁ and R₃, together with the atoms to which they are attached, form a five-membered heterocycle defined by the structure below when n is 1, or a six-membered heterocycle defined by the structure below when n is 2

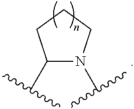

Poly(amino-acids), for example, polyarginine, polylysine, polyonithine, or polyhistidine may also be used to prepare the amino acid salt.

In other embodiments, the mobile carrier can be defined by a formula below

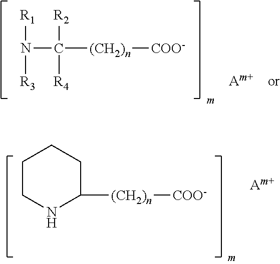

wherein R₁, R₂, R₃, and R₄ are hydrogen or hydrocarbon groups having from 1 to 4 carbon atoms, n is an integer ranging from 0 to 4, A^{m+} is a cation having a valence of 1 to 3. In some cases, the cation (A^{m+}) can be an amine cation having the formula:

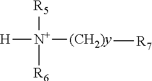

wherein R₅ and R₆ are hydrogen or hydrocarbon groups having from 1 to 4 carbon atoms, R₇ is hydrogen or hydrocarbon groups having from 1 to 4 carbon atoms or an alkyl amine of from 2 to 6 carbon atoms and 1 to 4 nitrogen atoms, y is an integer ranging from 1 to 4, and m is an integer equal to the valence of the cation. In some embodiments, A^{m+} is a metal cation selected from Groups Ia, IIa, and IIIa of the Periodic Table of Elements or a transition metal. For example, A^{m+} can comprise lithium, aluminum, or iron.

Other suitable mobile carriers include aminoisobutyric acid-potassium salt, aminoisobutyric acid-lithium salt, aminoisobutyric acid-piperazine salt, glycine-potassium salt, glycine-lithium salt, glycine-piperazine salt, dimethylglycine-potassium salt, dimethylglycine-lithium salt, dimethylglycine-piperazine salt, piperadine-2-carboxlic acid-potassium salt, piperadine-2-carboxlic acid-lithium salt, piperadine-2-carboxlic acid-piperazine salt, piperadine-4-carboxlic acid-potassium salt, piperadine-4-carboxlic acid-lithium salt, piperadine-4-carboxlic acid-piperazine salt, piperadine-3-carboxlic acid-potassium salt, piperadine-3-carboxlic acid-lithium salt, piperadine-3-carboxlic acid-piperazine salt, and blends thereof.

In some examples, the mobile carrier can be selected from a group consisting of 1,1,3,3-tetramethylguanidine, piperazine-1-carboximidamide, N-methylpiperazine-1-carboximidamide, N-ethylpiperazine-1-carboximidamide, N-propylpiperazine-1-carboximidamide, N-butylpiperazine-1-carboximidamide, N-pentylpiperazine-1-carboximidamide, N-hexylpiperazine-1-carboximidamide, N-heptylpiperazine-1-carboximidamide, N-octylpiperazine-1-carboximidamide, 2-(1-piperazinyl)ethylamine sarcosinate, 2-(1-piperazinyl)ethylamine glycinate, 2-(1-piperazinyl)ethylamine aminoisobutyrate, piperazine sarcosinate, piperazine glycinate, piperazine aminoisobutyrate, lithium sarcosinate, lithium glycinate, lithium aminoisobutyrate, potassium sarcosinate, potassium glycinate, potassium aminoisobutyrate, amidine with the structure R₁—(C═NH)—NR₂R₃ where each of R₁, R₂, and R₃ groups being H or R═CₙH₂ₙ₊₁ with n ranging from 1 to 10, guanidine with the structure R₁—N(R₂)—(C═NH)—NR₂R₄ where each of R₁, R₂, R₃, and R₄ groups being H or R═CₙH₂ₙ₊₁ with n ranging from 1 to 10, and a combination thereof.

### Amine-Containing Polymers

Optionally, the selective polymer matrix can further include an amine-containing polymer.

In some embodiments, the amine-containing polymer can include one or more primary amine moieties and/or one or more secondary amine moieties. In these embodiments, the amine-containing polymer can serve as an additional “fixed-site carrier.”

The amine-containing polymer can have any suitable molecular weight. For example, the amine-containing polymer can have a weight average molecular weight of from 5,000 Da to 5,000,000 Da, or from 50,000 Da to 2,000,000 Da. Suitable examples of amine-containing polymers include, but are not limited to, polyvinylamine, polyallylamine, polyethyleneimine, poly-N-isopropylallylamine, poly-N-tert-butylallylamine, poly-N-1,2-dimethylpropylallylamine, poly-N-methylallylamine, poly-N,N-dimethylallylamine, poly-2-vinylpiperidine, poly-4-vinylpiperidine, polyaminostyrene, chitosan, copolymers, and blends thereof. In some embodiments, the amine-containing polymer can comprise polyvinylamine (e.g., polyvinylamine having a weight average molecular weight of from 50,000 Da to 2,000,000 Da).

### Graphene Oxide

In some embodiments, the selective polymer matrix can further include graphene oxide.

The term “graphene” refers to a one-atom-thick planar sheet of sp2-bonded carbon atoms that are densely packed in a honeycomb crystal lattice. In one embodiment, it refers to a single-layer version of graphite.

The term “graphene oxide” herein refers to functionalized graphene sheets (FGS)—the oxidized compositions of graphite. These compositions are not defined by a single stoichiometry. Rather, upon oxidation of graphite, oxygen-containing functional groups (e.g., epoxide, carboxyl, and hydroxyl groups) are introduced onto the graphite. Complete oxidation is not needed. Functionalized graphene generally refers to graphene oxide, where the atomic carbon to oxygen ratio starts at approximately 2. This ratio can be increased by reaction with components in a medium, which can comprise a polymer, a polymer monomer resin, or a solvent, and/or by the application of radiant energy. As the carbon to oxygen ratio becomes very large (e.g., approaching 20 or above), the graphene oxide chemical composition approaches that of pure graphene.

The term “graphite oxide” includes “graphene oxide”, which is a morphological subset of graphite oxide in the form of planar sheets. “Graphene oxide” refers to a graphene oxide material comprising either single-layer sheets or multiple-layer sheets of graphite oxide. Additionally, in one embodiment, a graphene oxide refers to a graphene oxide material that contains at least one single layer sheet in a portion thereof and at least one multiple layer sheet in another portion thereof. Graphene oxide refers to a range of possible compositions and stoichiometries. The carbon to oxygen ratio in graphene oxide plays a role in determining the properties of the graphene oxide, as well as any composite polymers containing the graphene oxide.

The abbreviation “GO” is used herein to refer to graphene oxide, and the notation GO(m) refers to graphene oxide having a C:O ratio of approximately “m”, where m ranges from 3 to about 20, inclusive. For example, graphene oxide having a C:O ratio of between 3 and 20 is referred to as “GO(3) to GO(20)”, where m ranges from 3 to 20, e.g. m=3, 4, 5, 6, 7, 8, 9, 10, 11, 12, 13, 14, 15, 16, 17, 18, 19 or 20, including all decimal fractions of 0.1 increments in between, e.g. a range of values of 3-20 includes 3.0, 3.1, 3.2, 3.3, 3.4, 3.5, 3.6, 3.7, 3.8, 3.9, 4.0, and so on up to 20. Thus, as used herein, the term GO(m) describes all graphene oxide compositions having a C:O ratio of from 3 to about 20. For example, a GO with a C:O ratio of 6 is referred to as GO(6), and a GO with a C:O ratio of 8, is referred to as GO(8), and both fall within the definition of GO(m).

As used herein, “GO(L)” refers to low C:O ratio graphene oxides having a C:O ratio of approximately “L”, wherein L is less than 3, e.g., in the range of from about 1, including 1, up to 3, and not including 3, e.g. about 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, or about 2.9. In many embodiments, a GO(L) material has a C:O ratio of approximately 2. The designations for the materials in the GO(L) group is the same as that of the GO(m) materials described above, e.g., “GO(2)” refers to graphene oxide with a C:O ratio of 2.

In some embodiments, the graphene oxide can be GO((m). In some embodiments, the graphene oxide can be GO(L). In some embodiments, the graphene oxide can be nanoporous.

### Other Components

In some embodiments, the selective polymer matrix can further include a base. The base can act as a catalyst to catalyze the cross-linking of the selective polymer matrix (e.g., cross-linking of a hydrophilic polymer with an amine-containing polymer). In some embodiments, the base can remain in the selective polymer matrix and constitute a part of the selective polymer matrix. Examples of suitable bases include potassium hydroxide, sodium hydroxide, lithium hydroxide, triethylamine, N,N-dimethylaminopyridine, hexamethyltriethylenetetraamine, potassium carbonate, sodium carbonate, lithium carbonate, and combinations thereof. In some embodiments, the base can include potassium hydroxide. The selective polymer matrix can comprise any suitable amount of the base. For example, the selective polymer matrix can comprise 1 to 40 percent base by weight of the selective polymer matrix.

The selective polymer matrix can further comprise carbon nanotubes dispersed within the selective polymer matrix. Any suitable carbon nanotubes (prepared by any suitable method or obtained from a commercial source) can be used. The carbon nanotubes can comprise single-walled carbon nanotubes, multiwalled carbon nanotubes, or a combination thereof.

In some cases, the carbon nanotubes can have an average diameter of a least 10 nm (e.g., at least 20 nm, at least 30 nm, or at least 40 nm). In some cases, the carbon nanotubes can have an average diameter of 50 nm or less (e.g., 40 nm or less, 30 nm or less, or 20 nm or less). In certain embodiments, the carbon nanotubes can have an average diameter ranging from any of the minimum values described above to any of the maximum values described above. For example, the carbon nanotubes can have an average diameter of from 10 nm to 50 nm (e.g., from 10 nm to 30 nm, or from 20 nm to 50 nm).

In some cases, the carbon nanotubes can have an average length of at least 50 nm (e.g., at least 100 nm, at least 200 nm, at least 300 nm, at least 400 nm, at least 500 nm, at least 600 nm, at least 700 nm, at least 800 nm, at least 900 nm, at least 1 μm, at least 5 μm, at least 10 μm, or at least 15 μm). In some cases, the carbon nanotubes can have an average length of 20 μm or less (e.g., 15 μm or less, 10 μm or less, 5 μm or less, 1 μm or less, 900 nm or less, 800 nm or less, 700 nm or less, 600 nm or less, 500 nm or less, 400 nm or less, 300 nm or less, 200 nm or less, or 100 nm or less).

In certain embodiments, the carbon nanotubes can have an average length ranging from any of the minimum values described above to any of the maximum values described above. For example, the carbon nanotubes can have an average length of from 50 nm to 20 μm (e.g., from 200 nm to 20 μm, or from 500 nm to 10 μm).

In some cases, the carbon nanotubes can comprise unfunctionalized carbon nanotubes. In other embodiments, the carbon nanotubes can comprise sidewall functionalized carbon nanotubes. Sidewall functionalized carbon nanotubes are well known in the art. Suitable sidewall functionalized carbon nanotubes can be prepared from unfunctionalized carbon nanotubes, for example, by creating defects on the sidewall by strong acid oxidation. The defects created by the oxidant can subsequently converted to more stable hydroxyl and carboxylic acid groups. The hydroxyl and carboxylic acid groups on the acid treated carbon nanotubes can then be coupled to reagents containing other functional groups (e.g., amine-containing reagents), thereby introducing pendant functional groups (e.g., amino groups) on the sidewalls of the carbon nanotubes. In some embodiments, the carbon nanotubes can comprise hydroxy-functionalized carbon nanotubes, carboxy-functionalized carbon nanotubes, amine-functionalized carbon nanotubes, or a combination thereof.

In some embodiments, the selective polymer matrix can comprise at least 0.5% (e.g., at least 1%, at least 1.5%, at least 2%, at least 2.5%, at least 3%, at least 3.5%, at least 4%, or at least 4.5%) by weight carbon nanotubes, based on the total dry weight of the selective polymer matrix. In some embodiments, the selective polymer matrix can comprise 5% or less (e.g., 4.5% or less, 4% or less, 3.5% or less, 3% or less, 2.5% or less, 2% or less, 1.5% or less, or 1% or less) by weight carbon nanotubes, based on the total dry weight of the selective polymer matrix.

The selective matrix layer can comprise an amount of carbon nanotubes ranging from any of the minimum values described above to any of the maximum values described above. For example, the selective polymer matrix can comprise from 0.5% to 5% (e.g., from 1% to 3%) by weight carbon nanotubes, based on the total dry weight of the selective polymer matrix.

If desired, the selective polymer matrix can be surface modified by, for example, chemical grafting, blending, or coating to improve the performance of the selective polymer matrix. For example, hydrophobic components may be added to the selective polymer matrix to alter the properties of the selective polymer matrix in a manner that facilitates greater fluid selectivity.

The total thickness of each layer in the membrane can be chosen such that the structure is mechanically robust, but not so thick as to impair permeability. In some embodiments, the selective polymer layer can have a thickness of from 50 nanometers to 25 microns (e.g., from 100 nanometers to 750 nanometers, from 250 nanometers to 500 nanometers, from 50 nm to 2 microns, from 50 nm to 20 microns, or from 1 micron to 20 microns). In some embodiments, the support layer can have a thickness of from 1 micron to 500 microns (e.g., from 50 to 250 microns). In some cases, the membranes disclosed herein can have a thickness of from 5 microns to 500 microns.

### Methods of Making

Methods of making these membranes are also disclosed herein. Methods of making membranes can include depositing a selective polymer layer on a support layer to form a selective layer disposed on the support layer. The selective polymer layer can comprise a selective polymer matrix.

Optionally, the support layer can be pretreated prior to deposition of the selective polymer layer, for example, to remove water or other adsorbed species using methods appropriate to the support and the adsorbate. Examples of absorbed species are, for example, water, alcohols, porogens, and surfactant templates.

The selective polymer layer can be prepared by first forming a coating solution including the components of the selective polymer matrix (e.g., a polyamidine, a hydrophilic polymer, a cross-linking agent, a mobile carrier, an amine-containing polymer, or a combination thereof; and optionally a basic compound and/or graphene oxide in a suitable solvent). One example of a suitable solvent is water. In some embodiments, the amount of water employed will be in the range of from 50% to 99%, by weight of the coating solution. The coating solution can then be used in forming the selective polymer layer. For example, the coating solution can be coated onto a support later (e.g., a nanoporous gas permeable membrane) using any suitable technique, and the solvent may be evaporated such that a nonporous membrane is formed on the substrate. Examples of suitable coating techniques include, but are not limited to, “knife coating” or “dip coating”. Knife coating include a process in which a knife is used to draw a polymer solution across a flat substrate to form a thin film of a polymer solution of uniform thickness after which the solvent of the polymer solution is evaporated, at ambient temperatures or temperatures up to about 100° C. or higher, to yield a fabricated membrane. Dip coating include a process in which a polymer solution is contacted with a porous support. Excess solution is permitted to drain from the support, and the solvent of the polymer solution is evaporated at ambient or elevated temperatures. The membranes disclosed can be shaped in the form of hollow fibers, tubes, films, sheets, etc. In certain embodiments, the membrane can be configured in a flat sheet, a spiral-wound, a hollow fiber, or a plate-and-frame configuration.

In some embodiments, membranes formed from a selective polymer matrix containing for example, a polyamidine, a hydrophilic polymer, a cross-linking agent, and a mobile carrier can be heated at a temperature and for a time sufficient for cross-linking to occur. In one example, cross-linking temperatures in the range from 80° C. to 100° C. can be employed. In another example, cross-linking can occur from 1 to 72 hours. The resulting solution can be coated onto the support layer and the solvent evaporated, as discussed above. In some embodiments, a higher degree of cross-linking for the selective polymer matrix after solvent removal takes place at about 100° C. to about 180° C., and the cross-linking occurs in from about 1 to about 72 hours.

An additive may be included in the selective polymer layer before forming the selective polymer layer to increase the water retention ability of the membrane. Suitable additives include, but are not limited to, polystyrenesulfonic acid-potassium salt, polystyrenesulfonic acid-sodium salt, polystyrenesulfonic acid-lithium salt, sulfonated polyphenyleneoxides, alum, and combinations thereof. In one example, the additive comprises polystyrenesulfonic acid-potassium salt.

In some embodiments, the method of making these membranes can be scaled to industrial levels.

### Methods of Use

The membranes disclosed herein can be used for separating gaseous mixtures.

For example, provided are methods for separating CO₂ gas from a feed gas stream comprising CO₂ using the membranes described herein. These methods can include contacting a membrane described herein (e.g., on the side comprising the selective polymer) with the feed gas stream including the CO₂ gas under conditions effective to afford transmembrane permeation of the CO₂ gas.

In some embodiments, the method can also include withdrawing from the reverse side of the membrane a permeate containing at least the CO₂ gas as, wherein the CO₂ gas is selectively removed from the gaseous stream. The permeate can comprise at least the CO₂ gas in an increased concentration relative to the feed stream. The term “permeate” refers to a portion of the feed stream which is withdrawn at the reverse or second side of the membrane, exclusive of other fluids such as a sweep gas or liquid which may be present at the second side of the membrane.

The membrane can be used to separate fluids at any suitable temperature, including temperatures of 70° C. or greater. For example, the membrane can be used at temperatures of from 100° C. to 180° C. In some embodiments, the first gas stream can have a temperature of at least 77° C. In some embodiments, a vacuum can be applied to the permeate face of the membrane to remove the CO₂ gas. In some embodiments, a sweep gas can be flowed across the permeate face of the membrane to remove the CO₂ gas. Any suitable sweep gas can be used.

All of the compositions and methods disclosed and claimed herein can be made and executed without undue experimentation in light of the present disclosure. While the compositions and methods of this disclosure have been described in terms of preferred embodiments, it will be apparent to those of skill in the art that variations may be applied to the compositions and methods and in the steps or in the sequence of steps of the methods described herein without departing from the concept, spirit and scope of the disclosure. More specifically, it will be apparent that certain agents which are both chemically related may be substituted for the agents described herein while the same or similar results would be achieved. All such similar substitutes and modifications apparent to those skilled in the art are deemed to be within the spirit, scope and concept of the disclosure as defined by the appended claims.

By way of non-limiting illustration, examples of certain embodiments of the present disclosure are given below.

### EXAMPLES

### Overview

Described herein are polyamidine-containing membranes for separation of CO₂ from gaseous streams. The polymeric selective layer, coated on top of a highly permeable nanoporous polymer support, comprises a mixture of polyamidine and polyvinylamine as fixed-site carriers that serve as the polymer matrix to contain CO₂-reactive small molecules as mobile carriers. Both the fixed-site and mobile carriers facilitate the transport of CO₂ across the membrane. In addition to the polyamidine and polyvinylamine, the polymer matrix contains polyvinylalcohol optionally. Perforated graphene oxide mono-sheets were dispersed in the selective layer to reinforce the flexural rigidity of the selective layer in the membrane upon feed compression and vacuum suction. The membrane demonstrates excellent CO₂/N₂ separation performance

### Background

A widely engaged approach for polymeric membrane synthesis is to coat a thin selective layer of polymer onto a nanoporous polymer support, i.e., typically ultrafiltration membranes made from polysulfone, polyethersulfone, or polyetherimide. Multiple research efforts have been dedicated in designing polymers with high CO₂ permeance and decent CO₂/N₂ selectivity. On one hand, polar functional groups, such as ethylene oxide group, have been incorporated to increase the physical CO₂ solubility in the polymer matrix, and the dissolved CO₂ molecules diffuse through the membrane [5-7]. On the other hand, reactive functional groups and compounds have been used as carriers to reversibly react with CO₂ [8,9]. The chemical reaction enhances the permeation of CO₂ through the membrane, and this type of membrane is named as facilitated transport membrane.

For facilitated transport membranes, amines are the most exploited carriers. The reaction mechanisms between CO₂ and amines are depicted in Scheme I. The reactivity of CO₂ derives from the high electron deficiency of the carbon bonded to the two highly electronegative oxygens. For primary and secondary amines with a lone electron pair on the nitrogen atom, the amine functions as a nucleophile, i.e., a Lewis base, which attacks the electrophile carbonyl group on CO₂ to form a zwitterion. The zwitterion rapidly equilibrates to the corresponding carbamic acid and then is deprotonated by another amine to form a more stable carbamate ion, which leads to 2 moles of amine for 1 mole of CO_{2 [10}]. Many successes have been reported by exploring various amine structures, yielding highly CO₂-selective membranes with considerable CO₂ permeance [11-14].

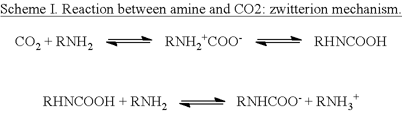

### Polyamidine-Containing Membranes

Although the amine structure can be further fine-tuned to enhance the CO₂ loading capacity such as using sterically hindered polyvinylamine membranes [15,16], there are other CO₂-reactive carriers that are worthwhile exploring. One promising candidate is a class of strong organic base, amidine. The amidine group has a high electron density due to the efficient resonance stabilization of the charges on its two amino groups connected to the carbon center. This feature can be capitalized for efficient CO₂ fixation as shown in the following scheme:

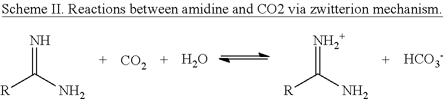

Amidine can attack the electron deficient carbon center of CO₂ as a nucleophile to form a zwitterion. The zwitterion can be further hydrolyzed to bicarbonate in the presence of water. The reaction mechanism leads to 1 mole of CO₂ for 1 mole of amidine, which is very effective for CO₂ sorption in a membrane containing the amidine.

In this example, we disclose the synthesis of polymeric membranes containing polyamidines for separation of CO₂ from gaseous streams. The polyamidine can be, for example, polyethylene formamidine, polytrimethylene formamidine, polytetramethylene formamidine, polypentamethylene formamidine, polyhexamethylene formamidine, polyheptamethylene formamidine, polyoctamethylene formamidine, polyethylene acetamidine, polytrimethylene acetamidine, polytetramethylene acetamidine, polypentamethylene acetamidine, polyhexamethylene acetamidine, polyheptamethylene acetamidine, polyoctamethylene acetamidine, poly(N-vinylamidine), poly(N-allylamidine), poly(N-butylamidine), poly(N-pentylamidine), poly(N-hexylamidine), poly(N-heptylamidine), poly(N-octylamidine), poly(5-member ring amidine) derived from N-vinylamine-co-acrylonitrile, copolymers thereof, and blends thereof.

The polymeric selective layer, coated on top of a highly permeable nanoporous polymer support, can include a mixture of the polyamidine and optionally polyvinylamine as fixed-site carriers that serve as the polymer matrix to contain CO₂-reactive small molecules as mobile carriers. Both the fixed-site and mobile carriers facilitate the transport of CO₂ across the membrane. In addition to the polyamidine and polyvinylamine, the polymer matrix contains polyvinylalcohol optionally.

Polyethylene formamidine (PEF) can be synthesized from the polycondensation of ethylene diamine (EDA) and triethyl orthoformate (TEOF) as follows:

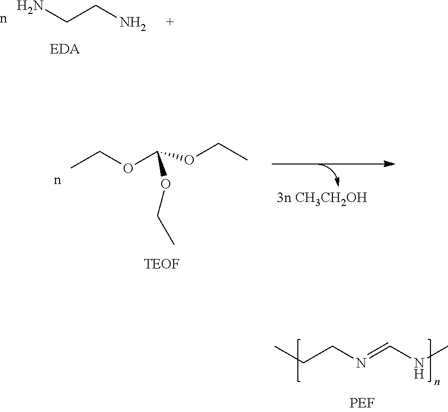

The leaving product, ethanol (CH₃CH₂OH), is removed from the polymer product.

Similarly, polytrimethylene formamidine and polytetramethylene formamidine can be synthesized from the polycondensation of triethyl orthoformate with 1,3-propane diamine and 1,4-butane diamine, respectively, as shown in the following:

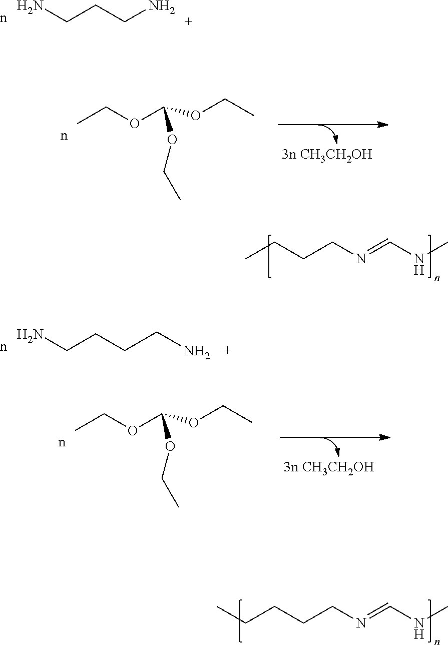

Polypentamethylene formamidine, polyhexamethylene formamidine, polyheptamethylene formamidine, and polyoctamethylene formamidine can also be synthesized from the polycondensation of triethyl orthoformate with 1,5-pentane diamine, 1,6-hexane diamine, 1,7-heptane diamine, and 1,8-octane diamine, respectively. In a similar way, polyethylene acetamidine, polytrimethylene acetamidine, polytetramethylene acetamidine, polypentamethylene acetamidine, polyhexamethylene acetamidine, polyheptamethylene acetamidine, and polyoctamethylene acetamidine can be prepared from the polycondensation of triethyl orthoacetate with ethylene diamine, 1,3-propane diamine, 1,4-butane diamine, 1,5-pentane diamine, 1,6-hexane diamine, 1,7-heptane diamine, and 1,8-octane diamine, respectively.

The mobile carrier can be, for example, 1,1,3,3-tetramethylguanidine, piperazine-1-carboximidamide, N-methylpiperazine-1-carboximidamide, N-ethylpiperazine-1-carboximidamide, N-propylpiperazine-1-carboximidamide, N-butylpiperazine-1-carboximidamide, N-pentylpiperazine-1-carboximidamide, N-hexylpiperazine-1-carboximidamide, N-heptylpiperazine-1-carboximidamide, N-octylpiperazine-1-carboximidamide, 2-(1-piperazinyl)ethylamine sarcosinate, 2-(1-piperazinyl)ethylamine glycinate, 2-(1-piperazinyl)ethylamine aminoisobutyrate, piperazine sarcosinate, piperazine glycinate, piperazine aminoisobutyrate, lithium sarcosinate, lithium glycinate, lithium aminoisobutyrate, potassium sarcosinate, potassium glycinate, potassium aminoisobutyrate, amidine with the structure R₁—(C═NH)—NR₂R₃ where each of R₁, R₂, and R₃ groups being H or R═CₙH₂ₙ₊₁ with n ranging from 1 to 10, guanidine with the structure R₁—N(R₂)—(C═NH)—NR₂R₄ where each of R₁, R₂, R₃, and R₄ groups being H or R═CₙH₂ₙ₊₁ with n ranging from 1 to 10, and a combination thereof.

Perforated graphene oxide mono-sheets can be dispersed in the selective layer to reinforce the flexural rigidity of the selective layer in the membrane upon feed compression and vacuum suction. These membranes demonstrate excellent CO₂/N₂ separation performance.

### Materials

2-(1-piperazinyl)ethylamine (PZEA, 99%), sarcosine (Sar, 98%), piperazine-1-carboximidamide, glacial acetic acid (99%), triethyl orthoformate (TEOF, 98%), ethylenediamine (EDA, 99%), and deuterium oxide (D₂O, 99.9 atom % D) were purchased from Sigma-Aldrich (Milwaukee, WI). Piperazine-1-carboximidamide (PZC, 99%) was bought from VWR (Radnor, PA). 1,4-Butane diamine (BDA, 99%) was purchased from Acros Organics (Somerville, NJ). Polyvinylalcohol (PVA, Poval S-2217, 92%) was given by Kuraray America Inc. (Houston, TX). Monolayer graphene oxide (GO) was acquired from TCI America (Portland, OR) in the form of solid flakes. All the chemicals, except GO that will be described later, were used as received without further purification. For gas permeation measurements, pre-purified CO₂ and argon were purchased from Praxair Inc. (Danbury, CT).

In terms of the amine-containing polymer, it is selected from a group, which can be but not limited to, consisting of polyvinylamine (PVAm), polyallylamine, polyethyleneimine, copolymers, and blends thereof. The amine-containing polymer PVAm employed in the examples was purified from a commercial product named Polymin® VX from BASF (Vandalia, IL). The PVAm had a high weight average molecular weight of 2,000 kDa. The amine-containing polymer can have a weight average molecular weight ranging from 300 to 3,000 kDa, but preferably to be higher than 1,000 kDa.

### Preparation of Nanoporous GO

The GO was dispersed in water (˜1 mg/ml) by an ultrasonication probe with a power of 2500 W for 3 hr. KOH solution (50 wt. %) was added slowly into the GO dispersion with a KOH-to-GO weight ratio of 14:1 to prevent the precipitation of GO. The mixture was further ultrasonicated for 30 min. After this, the water was evaporated in a convection oven at 60° C., followed by further drying in a vacuum oven at 60° C. overnight. The resultant solid was annealed at 200° C. for 2 h to create pores on the GO basal plane. After the thermal treatment, the solid was washed by DI water under vacuum filtration until the filtrate reached a pH of 7. The purified nanoporous GO (nGO) was dispersed in water again (˜1 mg/ml) using an ultrasonication bath.

### Coating Solution and Membrane Preparation

The nGO-reinforced composite membranes were synthesized by using the following procedures.

Firstly, the purified PVAm solution was concentrated to 4 wt. % by evaporating water under nitrogen purge at 50° C. The nGO dispersion with a concentration of ˜1 mg/ml was added dropwise to the polymer solution by a 10-μL glass capillary tube under vigorous agitation, aiming for 1.5 wt. % nGO loading in the final total solid of the coating solution. The mixture was transferred to a 15-mL conical centrifuge tube, in which it was homogenized by the ⅛″ Microtip sonication probe with a 50% amplitude until uniformly dispersed. The sonication was carried out in an ice bath. The water introduced by the nGO dispersion was vaporized by a nitrogen purge.

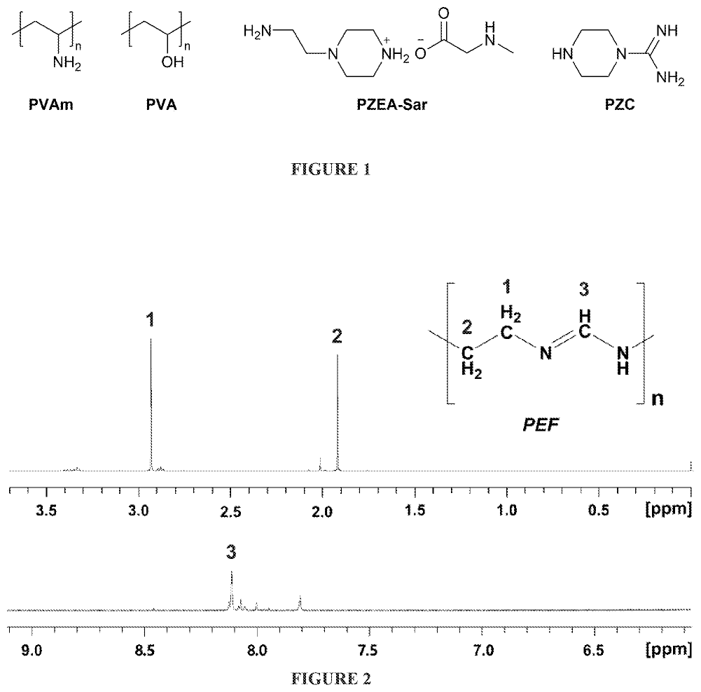

The aminoacid salt mobile carriers were synthesized by reacting the base, PZEA, with the aminoacid, Sar. The stoichiometric amount of Sar was added in a 24 wt. % PZEA aqueous solution under vigorous mixing. The solution was mixed at room temperature for 2 h before use. The chemical structures of PVAm, PVA, PZEA-Sar, and PZC are shown in FIG. 1.

The certain amounts of the mobile carrier solutions, including the aminoacid salt and/or PZC, were incorporated in the dispersion to form the coating solution. After centrifugation at 8,000×g for 3 min to remove any air bubbles and/or particulates, the coating solution was coated on a nanoporous polyethersulfone (PES) substrate by a GARDCO adjustable micrometer film applicator (Paul N. Gardner Company, Pompano Beach, FL) with a controlled gap setting. The PES substrate was synthesized in house with a surface average pore size of 35 nm [17]. Ideally, the coating solution should have a viscosity >1100 cp at a total solid content <15 wt. % in order to form a defect-free selective layer with a thickness of ca. 170 nm. The membrane was dried in a fume hood at room temperature for at least 6 h before testing.

### Gas Permeation Measurements

The transport properties of the composite membrane were measured by using a gas permeation apparatus [5,11-15]. The synthesized membrane was loaded into a stainless-steel rectangular permeation cell inside a temperature-controlled oven (Bemco Inc. Simi Valley, CA) with an effective area of 2.7 cm². The membrane was supported by a sintered stainless-steel plate with an average pore size of 100 μm. A 100-sccm dry feed gas containing 20% CO₂ and 80% N₂ was used. The mixed gas was achieved by mixing the two gas streams of CO₂ and N₂ controlled by two mass flow controllers, respectively. The feed gas was fully saturated with water vapor by bubbling through 100 mL water in a 500-mL stainless-steel humidifier (Swagelok, Westerville, OH) packed with 60 vol. % Raschig rings. The humidifier temperature was controlled at 57° C., which is the typical flue gas temperature leaving the flue gas desulfurization (FGD) unit. However, a higher temperature, e.g., 67 or 77° C., may also be used. The feed pressure was controlled at 1-5 atm (abs) by a near-ambient pressure regulator. The outlet gas was sent to an Agilent 6890N gas chromatography (GC, Agilent Technologies, Palo Alto, CA) for composition analysis after the moisture was knocked out by a condenser at room temperature. The GC was equipped with thermal conductivity detectors and a SUPELCO Carboxen® 1004 micropacked GC column (Sigma-Aldrich, St. Louis, MO).

The permeate side of the permeation cell was connected to an Ebara MD1 vacuum diaphragm pump (Ebara Technologies, Inc., Sacramento, CA). The permeate pressure was controlled precisely at 0.1-0.9 atm by a vacuum regulator (VC, Alicat Scientific, Inc., Tucson, AZ). Before the permeate stream entered the vacuum pump, it passed through a 1-L stainless-steel water knockout vessel that was cooled by a chiller (Fisher Scientific, Hampton, NH) at 0° C. to remove the moisture. A 30-sccm dry argon was used to carry the vacuum pump discharge to the GC for composition analysis.

### Example 1: Synthesis of Polyformamidines from Ethylenediamine

PEF was synthesized by the polycondensation of TEOF and EDA catalyzed by glacial acetic acid under a dry nitrogen atmosphere. Before the synthesis, a 50 mL three-neck round-bottom reaction flask that was connected to a distillation apparatus was dried by being immersed in an oil bath at 100° C. for an hour. After cooling to room temperature, 27.5 mmol EDA and 25.0 mmol TEOF were consecutively added into the reaction flask and stirred for 10 min. Then, 15.0 mmol glacial acetic acid was added into the reaction flask dropwise to be mixed with the monomers. In order to initiate the reaction, the oil bath temperature was raised to 110° C. at 1 atm in 15 min. Subsequently, the stirring strength was increased from the medium level to the maximum level with vigorous mixing to finish the condensation of the reaction byproduct ethanol in 35 min. After cooling, the polycondensation process was continued by reducing the reaction pressure to 10 torr. Under the vacuum, the oil bath temperature was slowly raised to 180° C. in 60 min for further polymerization. Finally, the reaction system was cooled to room temperature, and the vacuum was released before the polymer product was collected. The yield of PEF, calculated based on the amount of TEOF, was up to 85.7%. The PEF product was ion-exchanged by using Purolite® A600OH anion-exchange resin to remove the acetic acid before further use.

The 400 MHz ¹H nuclear magnetic resonance (NMR) spectrum of the purified PEF is shown in FIG. 2. Due to the resonance stabilization of the formamidine (—N═CH—NH—) groups (coded as 3, at ˜8.10 ppm), the methylene groups coded as 1 and 2 appeared at ˜2.94 ppm and ˜1.90 ppm, respectively, according to how close they were relative to the formamidine group.

The purified PEF was also characterized by Fourier transform infrared (FTIR) spectroscopy using a Nicolet 470 FTIR spectrometer (Thermo Electron Co., Waltham, MA) to confirm the characteristic bands of ethyl formamidine as presented in FIG. 3. The characteristic —N═C— peak of the formamidine group appeared around 1556.97 cm⁻¹. Absorption bands due to the N—H stretching vibration (˜3290.99 cm⁻¹), C—H stretching vibration (˜2933.99 cm⁻¹), and N—H deformation vibration (˜1398.97 cm⁻¹) of the formamidine group were also observed.

### Example 2: Synthesis of Polyformamidines from 1,4-Butane Diamine

Polytetramethylene formamidine (PTF) was synthesized by the polycondensation of TEOF and BDA catalyzed by glacial acetic acid under a dry nitrogen atmosphere. Before the synthesis, a 50 mL three-neck round-bottom reaction flask that was connected to a distillation apparatus was dried by being immersed in an oil bath at 100° C. for an hour. After cooling to room temperature, 50 mmol BDA and 55 mmol TEOF were consecutively added into the reaction flask and stirred for 10 min. Then, 50 mmol glacial acetic acid was added into the reaction flask dropwise to be mixed with the monomers. In order to initiate the reaction, the oil bath temperature was raised to 160° C. at 1 atm in 90 min to finish the condensation of the reaction byproduct ethanol. After cooling, the polycondensation process was continued by reducing the reaction pressure to 10 torr. Under the vacuum, the oil bath temperature was quickly raised to 220° C. in 35 min for further polymerization. Finally, the reaction system was cooled to room temperature, and the vacuum was released before the polymer product was collected. The yield of PTF, calculated based on the amount of BDA, was up to 93.4%. The PTF product was ion-exchanged by using Purolite® A600OH anion-exchange resin to remove the acetic acid before further use.

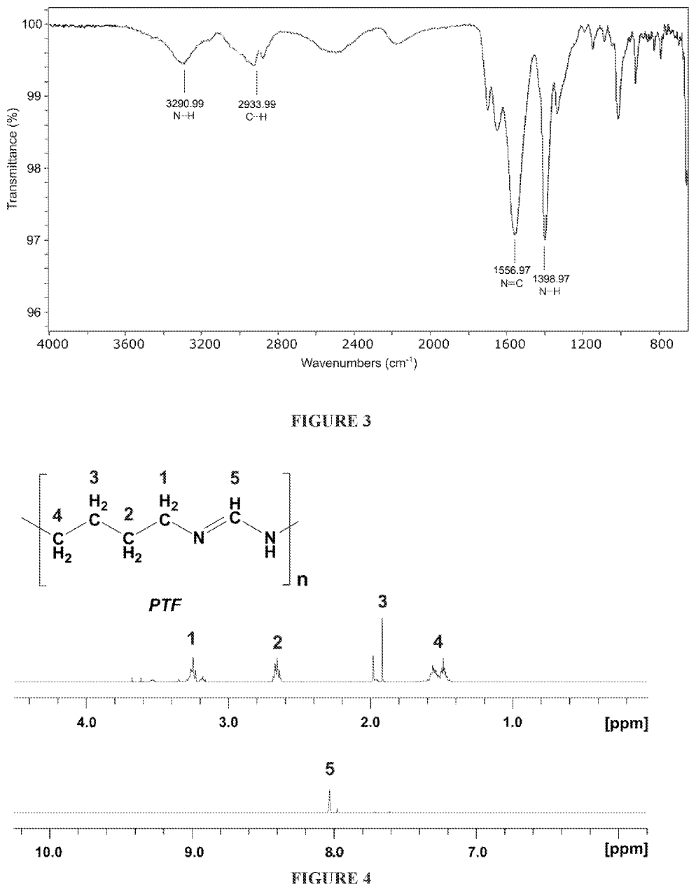

The ¹H NMR spectrum of the purified PTF is shown in FIG. 4. Due to the resonance stabilization of the formamidine (—N═CH—NH—) groups (coded as 5, at ˜8.05 ppm), the methylene groups coded as 1-4 appeared at ˜3.23 ppm, ˜2.63 ppm, ˜1.95 ppm, and ˜1.50 ppm, respectively, according to how close they were relative to the formamidine group.

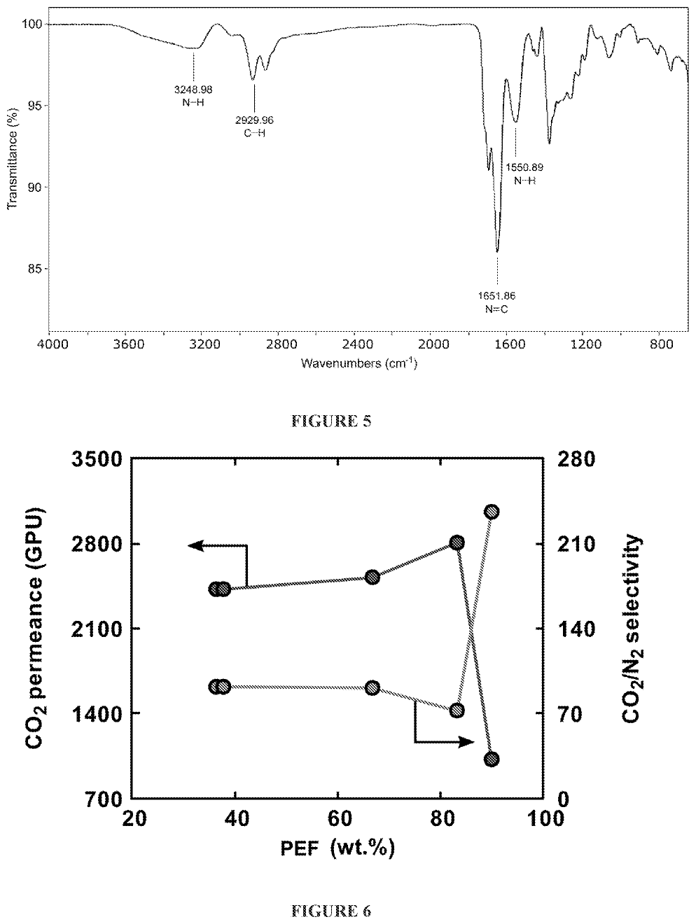

The purified PTF was also characterized by FTIR spectroscopy to confirm the characteristic bands of tetramethyl formamidine as presented in FIG. 5. The characteristic —N═C— band of the formamidine group appeared around 1651.86 cm⁻¹. The IR spectrum of PTF also exhibited absorption bands due to the N—H stretching vibration (˜3248.98 cm-1), C—H stretching vibration (˜2929.96 cm⁻¹), and N—H deformation vibration (˜1550.89 cm⁻¹) of the formamidine group.

### Example 3: Membranes Formed Using Polyformamidines Synthesized from Ethylenediamine

Membranes including PEF and PVA were prepared by the following steps. Firstly, PVA was dissolved in water and stirred overnight to form a 4 wt. % aqueous solution. A calculated amount of PEF was then blended into the PVA solution to form the coating solution. After being stirred for 2 hours, the coating solution was coated on a nanoporous PES substrate to form a 170-nm thick selective layer by using a GARDCO adjustable micrometer film applicator with a controlled gap setting. The membranes were dried in a fume hood at room temperature overnight before testing.

The membrane composed of 36 wt. % PEF and 64 wt. % PVA showed a CO₂ permeance of 2421 GPU with a CO₂/N₂ selectivity of 89 at 77° C. As shown in FIG. 6, by increasing the content of PEF from 36 to 66 wt. %, the membrane performance was substantially improved, especially for the CO₂ permeance. Further increasing the PEF content to 83 wt. % further enhanced the CO₂ permeance significantly but also led to a moderate drop in CO₂/N₂ selectivity. Under an extremely high PEF content of 90 wt. %, the CO₂ permeance dropped to 1019 GPU but the CO₂/N₂ selectivity was up to 236, indicating a severe pore penetration, presumably due to the extremely high content of PEF with its low molecular weight (M_{w}=1.54 MDa). Overall, the membrane containing 83 wt. % PEF and 17 wt. % PVA exhibited the best result with a CO₂ permeance of 2807 GPU and a CO₂/N₂ selectivity of 72.

### Example 4: Membranes Including Mobile Carriers

Mobile carriers, including PZEA-Sar and PZC, were incorporated into the polyformamidines in this example. All membranes included 40 wt. % mobile carriers with 1:1 weight ratio of PZEA-Sar and PZC. In order to enhance the coating solution viscosity, 5 wt. % PVAm was added. The remaining 55 wt. % included PEF (M_{w}=1.26 MDa) and PTF (M_{w}=4.40 MDa) as exemplified in Examples 1 and 2, respectively. The PEF content was varied between 18-44 wt. %, and the balance was PTF.

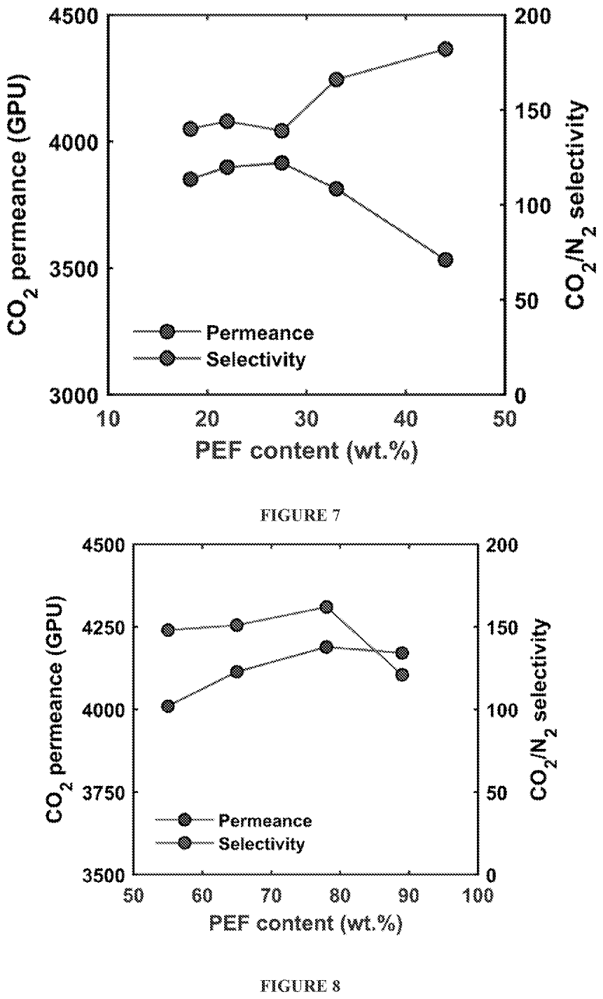

The aforementioned membranes were tested at 77° C. with a feed pressure of 4 atm and a vacuum pressure of 0.4 atm. The transport results are shown in FIG. 7. As seen, the CO₂ permeance increased from 3851 to 3915 GPU with increasing PEF content from 18.3 to 27.5 wt. %. Similar CO₂/N₂ selectivities of ca. 140 were observed in this range of PEF content. At a higher PEF content, however, the CO₂ permeance reduced significantly, which was accompanied by an increase in CO₂/N₂ selectivity. Particularly, the membrane containing 44 wt. % PEF exhibited a reduced CO₂ permeance of 3533 GPU and a high CO₂/N₂ selectivity of 182. This observation was consistent with the severe pore penetration induced by a high content of PEF as discussed in Example 3.

The pore penetration issue at a high content of PEF was partially caused by the mobile carriers, which weakened the polymer matrix in the presence of excessive low MW moieties. In order to strengthen the polymer matrix while maintaining a high content of amidine groups, PZC was removed, and PZEA-Sar was used as the only mobile carrier. Similarly, PEF with a higher M_{w} of 7.70 MDa was used as the only polyamidine fixed-site carrier, and PVAm was used as the viscosity enhancer. In these membranes, the PVAm content was kept at 5 wt. %, and the PEF content was varied between 55-89 wt. % with balance of PZEA-Sar. As shown in FIG. 8, the CO₂ permeance increased from 4010 to 4189 GPU when the PEF content was increased from 55 to 78 wt. %. Correspondingly, the CO₂/N₂ selectivity also increased from 147 to 162. One exception was the membrane with 89 wt. % PEF, where the insufficient amount of ionic species resulted in a higher N₂ permeance.

### Example 5: Membranes Including Polyformamidines Synthesized from 1,4-Butane Diamine

Membranes including PVA and PTF with a weight ratio of 1.65:1 were prepared by the following steps. Firstly, PVA was dissolved in water and stirred overnight to form a 4 wt. % aqueous solution. A calculated amount of purified PTF was then blended into the PVA solution to form the coating solution. After being stirred for 2 hours, the coating solution was coated on a nanoporous PES substrate by using a GARDCO adjustable micrometer film applicator with a controlled gap setting. Finally, the membranes were dried in a fume hood at room temperature overnight. As PTF contains more carbon than PEF, i.e., PTF has less amidine content than PEF, it is expected that the PTF-containing membranes may not perform as well as the PEF-containing counterparts. However, the PTF-containing membranes can still be effective and useful for CO₂/N₂ separation

### REFERENCES

[1] International Energy Agency, CO₂ emissions—Global energy review 2021, available at https://www.iea.org/reports/global-energy-review-2021/co2-emissions, accessed Mar. 1, 2022.
[2] V Andreoni, S. Galmarini, Drivers in CO₂ emissions variation: A decomposition analysis for 33 world countries, Energy, 103 (2016) 27-37.
[3] J. Black, Cost and Performance Baseline for Fossil Energy Plants Volume 1: Bituminous Coal and Natural Gas to Electricity Final report, 2nd ed., National Energy Technology Laboratory, November, 2010.
[4] W. S. W. Ho, K. K. Sirkar, Membrane Handbook, Chapman & Hall, New York, 1992, Kluwer Academic Publishers, Boston, reprint edition, 2001.
[5] Y. Chen, B. Wang, L. Zhao, P. Dutta, W. S. W. Ho, New Pebax®/zeolite Y composite membranes for CO₂ capture from flue gas, J. Membr. Sci., 49 (2015) 415-423.
[6] W. Yave, A. Car, J. Wind, K.-V. Peinemann, Nanometric thin film membranes manufactured on square meter scale: Ultra-thin films for CO₂ capture, Nanotechnology, 21 (2010) 395301.
[7] W. Yave, A. Car, S. S. Funari, S. P. Nunes, K.-V. Peinemann, CO₂-philic polymer membrane with extremely high separation performance, Macromolecules, 43 (2009) 326-333.
[8] Y. Han, W. S. W. Ho, Recent advances in membranes for CO₂ capture, Chin. J. Chem. Eng., 26 (2018) 2238-2254.
[9] Y. Han, W. S. W. Ho, Polymeric membranes for CO₂ separation and capture”, J. Membr. Sci 628(2021), 119244.
[10] P. Danckwerts, The reaction of CO₂ with ethanolamines, Chem. Eng. Sci., 34 (1979) 443-446.
[11] Y. Han, D. Wu, W. S. W. Ho, Simultaneous effects of temperature and vacuum and feed pressures on facilitated transport membrane for CO₂/N₂ separation, J. Membr. Sci., 573 (2019) 476-484.
[12] Y Han, D. Wu, W. S. W. Ho, Nanotube-reinforced facilitated transport membrane for CO₂/N₂ separation with vacuum operation, J. Membr. Sci., 567 (2018) 261-271.
[13] Y. Chen, W. S. W. Ho, High-molecular-weight polyvinylamine/piperazine glycinate membranes for CO₂ capture from flue gas, J. Membr. Sci., 514 (2016) 376-384.
[14] Y Chen, L. Zhao, B. Wang, P. Dutta, W. S. W. Ho, Amine-containing polymer/zeolite Y composite membranes for CO₂/N₂ separation, J. Membr. Sci., 497(2016) 21-28.
[15] Z. Tong, W. S. W. Ho, New sterically hindered polyvinylamine membranes for CO₂ separation and capture, J. Membr. Sci., 543 (2017) 202-211.
[16] T.-Y. Chen, X. Deng, L.-C. Lin, W. S. W. Ho, New sterically hindered polyvinylamine-containing membranes for CO₂ capture from flue gas, J. Membr. Sci., 645, 120195 (2022).
[17] R. Pang, K. K. Chen, Y. Han, W. S. W. Ho, Highly permeable polyethersulfone substrates with bicontinuous structure for composite membranes in CO₂/N₂ separation, J. Membr. Sci., 612(2020), 118443.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated.

1. A membrane comprising:
a support layer, and
a selective polymer layer disposed on the support layer, the selective polymer layer comprising a selective polymer matrix,
wherein the selective polymer matrix comprises a fixed carrier comprising a polyamidine.

2. The membrane of claim 1, wherein the polyamidine has a weight average molecular weight of at least 2,500 Da, such as at least 5,000 Da, or at least 10,000 Da.

3. The membrane of claim 1, wherein the polyamidine is chosen from polyethylene formamidine, polytrimethylene formamidine, polytetramethylene formamidine, polypentamethylene formamidine, polyhexamethylene formamidine, polyheptamethylene formamidine, polyoctamethylene formamidine, polyethylene acetamidine, polytrimethylene acetamidine, polytetramethylene acetamidine, polypentamethylene acetamidine, polyhexamethylene acetamidine, polyheptamethylene acetamidine, polyoctamethylene acetamidine, poly(N-vinylamidine), poly(N-allylamidine), poly(N-butylamidine), poly(N-pentylamidine), poly(N-hexylamidine), poly(N-heptylamidine), poly(N-octylamidine), poly(5-member ring amidine) derived from N-vinylamine-co-acrylonitrile, copolymers thereof, and blends thereof.

4. The membrane of claim 1, wherein the polyamidine comprises polytetramethylene formamidine (PTF), polyethylene formamidine (PEF), or a blend thereof.

5. The membrane of claim 1, wherein the selective polymer layer further comprises a hydrophilic polymer, a cross-linking agent, amine-containing polymer, a mobile carrier, or a combination thereof.

6. The membrane of claim 1, wherein the selective polymer layer further comprises a mobile carrier.

7. (canceled)

8. (canceled)

9. The membrane of claim 5, wherein the mobile carrier comprises 1,1,3,3-tetramethylguanidine, piperazine-1-carboximidamide, N-methylpiperazine-1-carboximidamide, N-ethylpiperazine-1-carboximidamide, N-propylpiperazine-1-carboximidamide, N-butylpiperazine-1-carboximidamide, N-pentylpiperazine-1-carboximidamide, N-hexylpiperazine-1-carboximidamide, N-heptylpiperazine-1-carboximidamide, N-octylpiperazine-1-carboximidamide, 2-(1-piperazinyl)ethylamine sarcosinate, 2-(1-piperazinyl)ethylamine glycinate, 2-(1-piperazinyl)ethylamine aminoisobutyrate, piperazine sarcosinate, piperazine glycinate, piperazine aminoisobutyrate, lithium sarcosinate, lithium glycinate, lithium aminoisobutyrate, potassium sarcosinate, potassium glycinate, potassium aminoisobutyrate, an amidine with the structure R₁—(C═NH)—NR₂R₃ where each of R₁, R₂, and R₃ groups being H or R═CₙH₂₊₁ with n ranging from 1 to 10, guanidine with the structure R₁—N(R₂)—(C═NH)—NR₂R₄ where each of R₁, R₂, R₃, and R₄ groups being H or R═CₙH₂ₙ₊₁ with n ranging from 1 to 10, or a combination thereof.

10. The membrane of claim 1, wherein the selective polymer matrix further comprises a hydrophilic polymer and a cross-linking agent.

11. The membrane of claim 10, wherein the cross-linking agent is selected from the group consisting of formaldehyde, glutaraldehyde, maleic anhydride, glyoxal, divinylsulfone, toluenediisocyanate, trimethylol melamine, terephthalatealdehyde, epichlorohydrin, vinyl acrylate, an aminosilane cross-linking agent, and combinations thereof.

12. The membrane of claim 10, wherein the hydrophilic polymer comprises a polymer selected from the group consisting of polyvinylalcohol, polyvinylacetate, polyethylene oxide, polyvinylpyrrolidone, polyacrylamine, and copolymers thereof, or blends thereof.

13. The membrane of claim 1, wherein the selective polymer matrix further comprises an amine-containing polymer.

14. The membrane of claim 13, wherein the amine-containing polymer is selected from the group consisting of polyvinylamine, polyallylamine, polyethyleneimine, poly-N-isopropylallylamine, poly-N-tert-butylallylamine, poly-N-1,2-dimethylpropylallylamine, poly-N-methylallylamine, poly-N,N-dimethylallylamine, poly-2-vinylpiperidine, poly-4-vinylpiperidine, polyaminostyrene, chitosan, copolymers, and blends thereof.

15. The membrane of claim 1, wherein the support layer comprises a gas permeable polymer.

16. The membrane of claim 15, wherein the gas permeable polymer comprises a polymer chosen from polyamides, polyimides, polypyrrolones, polyesters, sulfone-based polymers, nitrile-based polymers, polymeric organosilicones, fluorinated polymers, polyolefins, copolymers thereof, and blends thereof.

17. The membrane of claim 16, wherein the gas permeable polymer comprises polyethersulfone or polysulfone.

18. The membrane of claim 1, wherein the support layer comprises a gas permeable polymer disposed on a base.

19. (canceled)

20. (canceled)

21. (canceled)

22. The membrane of claim 1, wherein the selective polymer layer further comprises graphene oxide dispersed therein.

23. (canceled)

24. The membrane of claim 1, wherein the membrane has a CO₂:N₂ selectivity of at least 50 at 77° C. and 4 atm feed pressure.

25. (canceled)

26. The membrane of claim 1, wherein the membrane has a CO₂ permeance of at least 750 GPU at 77° C. and 4 atm feed pressure.

27. (canceled)

28. A method for separating CO₂ gas from a gas stream comprising CO₂ and a second gas, the method comprising contacting a membrane defined by claim 1 with the feed gas stream comprising the CO₂ under conditions effective to afford transmembrane permeation of the CO₂.
